(19) United States
(12) Patent Application Publication
(10) Pub. No.: US 2012/0200672 A1
(43) Pub. Date: Aug. 9, 2012

(54) 3D IMAGING DEVICE

(75) Inventors: Mitsumasa ADACHI, Gifu-shi (JP); Soji MASUI, Nagoya-shi (JP); Etsuya TAKAMI, Yokohama-shi (JP)

(73) Assignee: JVC KENWOOD CORPORATION, Yokohama-shi (JP)

(21) Appl. No.: 13/369,053

(22) Filed: Feb. 8, 2012

(30) Foreign Application Priority Data
Feb. 8, 2011 (JP) 2011-025206
Dec. 28, 2011 (JP) 2011-287986

(51) Int. Cl. H04N 13/02

(52) U.S. Cl. 348/46; 348/E13.074

(57) ABSTRACT

A 3D imaging device includes: a first imaging unit having a first variable power lens and a first driving unit that drives the first variable power lens along an optical axis; a second imaging unit having a second variable power lens and a second driving unit that drives the second variable power lens along an optical axis; a storage unit that temporarily stores the first photographic image and the second photographic image; a parallax determining unit that determines a parallax in a horizontal direction between the first photographic image and the second photographic image; a parallax adjusting unit that generates a third photographic image excluding a first parallax adjusting image from the first photographic image and a fourth photographic image excluding a second parallax adjusting image from the second photographic image; and a photographic information recording unit that records information about a magnification of the first variable power lens.

### CROSS-REFERENCE TO RELATED APPLICATIONS

The present application claims priority to and incorporates by reference the entire contents of Japanese Patent Application No. 2011-025206 filed in Japan on Feb. 8, 2011 and Japanese Patent Application No. 2011-287986 filed in Japan on Dec. 28, 2011.

### BACKGROUND OF THE INVENTION

1. Field of the Invention

The present invention relates to a 3D imaging device and more particularly to a 3D imaging device for adjusting a three-dimensionality of a subject image corresponding to a zoom magnification.

2. Description of the Related Art

In recent years, there has been vigorously developed the technique related to a 3D image in which two images having a parallax in a horizontal direction are displayed as images for left and right eyes on the same display, and an observer observes the image for a left eye and the image for a right eye with the left and right eyes independently, respectively so that a subject image displayed on the display can be perceived as if it were present three-dimensionally.

As a method of displaying and observing a 3D image, there is well known a method of superimposing images for left and right eyes having linearly polarized lights which are orthogonal to each other and displaying them on the same display, and causing an observer to independently observe the respective images with the left and right eyes by wearing glasses having a polarizing filter.

Moreover, there is also well-known a system or the like in which respective images for left and right eyes are alternately displayed on a display and an observer independently observes the respective images with the left and right eyes by wearing glasses having a liquid crystal shutter for alternately shielding left and right visual fields.

In these techniques related to the 3D image, a degree at which a subject image is perceived to be protruded forward with respect to a display surface as seen from an observer or a degree at which the subject image is recessed rearward with respect to the display surface as seen from the observer is determined depending on a parallax in a horizontal direction between the images for left and right eyes.

Therefore, there has been vigorously developed the technique related to an imaging device for photographing a 3D image while adjusting a parallax in a horizontal direction between images for left and right eyes. For example, Japanese Laid-open Patent Publication No. 2010-147940 discloses an imaging device for detecting face image data on a person to be a subject from photographic image data for left and right eyes recorded temporarily in memory and adjusting slicing areas of photographic data for left and right eyes based on a difference vector between the face image data, thereby enabling a photographer to photograph a 3D image having an adjusted parallax in a horizontal direction between images for left and right eyes.

Referring to the imaging device described in the Japanese Laid-open Patent Publication No. 2010-147940, reading area of each photographic image data transmitted from memory is regulated to adjust a parallax between a photographic image for the left eye and a photographic image for the right eye.

However, when a reading area in a horizontal direction of image data transmitted from memory is changed, an optical axis of a lens of an imaging system does not coincide with a quasi-recognized optical axis for a photographic image read out from the memory. Therefore if a zoom magnification when a parallax is adjusted is switched to another zoom magnification: although a convergence point where the optical axis of the lens of the imaging system crosses does not change, a convergence point of the quasi-recognized optical axis for the photographic image recognized by an observer changes. As a result, there has been a problem in that a 3D image to be photographed is changed to have a three-dimensionality which is different from that intended before the switching of the zoom magnification, that is, a protrusion degree or a retraction degree which is different from that intended.

### SUMMARY OF THE INVENTION

It is an object of the present invention to at least partially solve the problems in the conventional technology.

According to an aspect of the present invention a 3D imaging device includes: a first imaging unit having a first variable power lens and a first driving unit that drives the first variable power lens along an optical axis, and acquiring first photographic image data; a second imaging unit having a second variable power lens and a second driving unit that drives the second variable power lens along an optical axis, and acquiring second photographic image data; a storage unit that temporarily stores the first photographic image and the second photographic image; a parallax determining unit that determines a parallax in a horizontal direction between the first photographic image and the second photographic image which are stored in the storage unit; a parallax adjusting unit that generates a third photographic image excluding a first parallax adjusting image from the first photographic image and a fourth photographic image excluding a second parallax adjusting image from the second photographic image based on the parallax in the horizontal direction which is determined by the parallax determining unit; and a photographic information recording unit that records photographic information about a magnification of the first variable power lens in an acquirement of the first photographic image, a magnification of the second variable power lens in an acquirement of the second photographic image, a size of the first parallax adjusting image and a size of the second parallax adjusting image. When a fifth photographic image with the magnification of the first variable power lens changed by the first driving unit is acquired from the third photographic image and a sixth photographic image with the magnification of the second variable power lens changed by the second driving unit is acquired from the fourth photographic image, the parallax adjusting unit determines sizes of a third parallax adjusting image and a fourth parallax adjusting image based on the changed magnifications. The photographic information recorded in the photographic information recording unit, generates a seventh photographic image excluding the third parallax adjusting image from the fifth photographic image, and generates an eighth photographic image excluding the fourth parallax adjusting image from the sixth photographic image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of an internal structure of an imaging device 1 according to an embodiment of the present invention;

FIG. 2 is a view illustrating a structure of a liquid crystal monitor 141 provided in the imaging device 1;

FIG. 3 is a flow chart for explaining a processing for generating a 3D image which maintains a three-dimensionality intended before a change in a zoom magnification also after the change in the zoom magnification through the imaging device 1;

FIGS. 4A and 4B are conceptual views for explaining a determination of a parallax between photographic image data for a left eye and photographic image data for a right eye through a parallax determining unit 121 and an adjustment of the parallax between both of the photographic image data through a parallax adjusting unit 122;

FIG. 5 is a view for explaining an example of a display in the case in which a result of a face detection carried out by a face detecting unit 124 is displayed on the liquid crystal monitor 141;

FIG. 6 is a conceptual view for explaining a calculation of an area of a face image through the parallax determining unit 121;

FIG. 7 is a conceptual view for explaining a calculation of a reference point and a corresponding point in the face image through the parallax determining unit 121;

FIGS. 5A and 8B are conceptual views for explaining another example of a determination of the parallax between the photographic image for a left eye and the photographic image data for a right eye through the parallax determining unit 121 and an adjustment of the parallax between both of the photographic image data through the parallax adjusting unit 122;

FIGS. 9A and 9B are conceptual views for explaining a problem caused in the case in which a parallax adjusting image is excluded from the photographic image data for a left eye and the photographic image data for a right eye which are recorded in SDRAM 133 and a zoom magnification is then changed;

FIG. 10 is a conceptual view for explaining a readjustment of the parallax between the image data for a left eye and the image data for a right eye through the parallax adjusting unit 122 in the case in which the zoom magnification is changed;

FIG. 11 is a view for explaining an adjustment of a parallax in a horizontal direction through the parallax adjusting unit 122;

FIG. 12 is a view for explaining a result of the parallax adjustment in the horizontal direction through the parallax adjusting unit 122;

FIG. 13 is a conceptual view illustrating a relationship between photographic image data for a left eye related to an image output area, photographic image data for a right eye related to an image output area, and an optical axis of an imaging unit for a left eye and an optical axis of an imaging unit for a right eye after the execution of the parallax adjustment through the parallax adjusting unit 122;

FIG. 14 is a conceptual view for explaining a problem caused in the case in which the parallax adjusting image is excluded from the photographic image data for a left eye and the photographic image data for a right eye which are recorded in the SDRAM 133 and the zoom magnification is then changed;

FIG. 15 is a conceptual view for explaining a readjustment of the parallax between the image data for a left eye and the image data for a right eye through the parallax adjusting unit 122 in the case in which the zoom magnification is changed; and

FIG. 16 is a view for explaining a result of the readjustment of the parallax corresponding to the change in the zoom magnification in the case in which the parallax adjustment is carried out and the zoom magnification is then changed.

### DETAILED DESCRIPTION OF THE PREFERRED EMBODIMENTS

A preferred embodiment according to the present invention will be described below in detail with reference to the accompanying drawings. Dimensions, materials, other specific numeric values and the like according to the embodiment are only illustrative for easy understanding of the invention and the present invention is not limited thereto unless otherwise specified. In this specification and the drawings, elements having substantially the same functions and structures have the same designations and repetitive description will be thereby omitted, and elements having no direct relationship with the present invention will not be illustrated in the drawings.

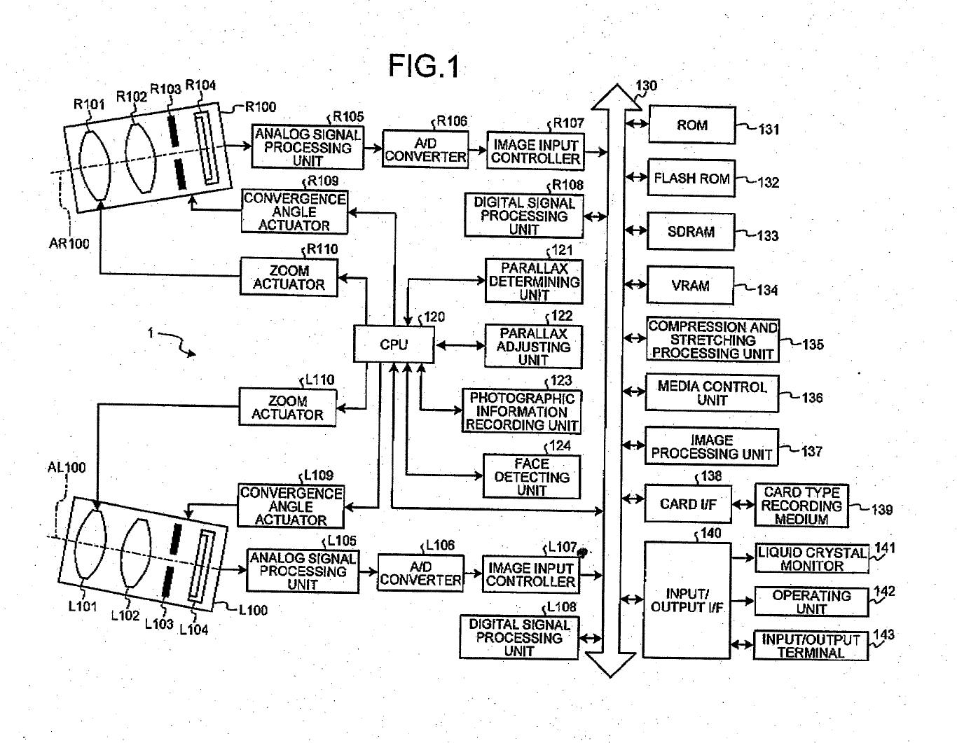

FIG. 1 is a block diagram illustrating an example of an internal structure of an imaging device (a digital video camera) 1 according to an embodiment of the present invention. The imaging device 1 can photograph a moving image and a static image.

The imaging device 1 according to the present embodiment includes two imaging units and has a structure in which angles of convergence formed by respective optical axes can be regulated. The present invention also can be applied to an imaging device which is fixed to cause both of the optical axes to be parallel with each other and cannot regulate an angle of convergence. Moreover, the present invention can also be applied to a digital still camera, and furthermore, other electronic apparatuses capable of carrying out photographing, for example, a portable telephone, a PHS (Personal Handyphone System), a PDA (Personal Digital Assistant) and the like.

A CPU 120 controls an operation of the imaging device 1 as a whole, for example, photographing, displaying, recording or the like. Moreover, the CPU 120 controls each unit in accordance with a predetermined control program based on an input from an operating unit 142.

In the imaging device 1, a pair of left and right imaging units for left and right eyes L100 and R100 are provided apart from each other at a predetermined interval (for example, 5 cm) which is slightly shorter than an interval between human eyes. Each of the imaging units for left and right eyes L100 and R100 includes zoom lenses L101 and R101, focus lenses L102 and R102, diaphragms L103 and R103, and solid state image sensors L104 and R104 respectively.

The zoom lenses L101 and R101 move along optical axes AL100 and AR100 by means of zoom actuators L110 and R110 respectively. The zoom actuators L110 and R110 include a stepping motor respectively.

The focus lenses L102 and R102 move along the optical axes AL100 and AR100 by means of focus actuators which are not illustrated. The diaphragms L103 and R103 are driven and operated by a diaphragm actuator which is not illustrated.

The imaging unit for the left eye L100 and the imaging unit for the right eye R100 are connected to convergence angle actuators L109 and R109 respectively, and the convergence angle actuators L109 and R109 drive both of the imaging units to regulate an angle of convergence which is formed by the optical axes AL100 and AR100 upon receiving a command from the CPU 120.

ROM 131 is connected to the CPU 120 through a data bus 130 and stores a control program to be executed by the CPU 120, various data required for the control, and the like. Flash ROM 132 stores various kinds of set information including information set by the user and the like related to an operation of the imaging device 1.

SDRAM 133 is used as a calculating work area of the CPU 120 and as a temporary storage area of image data. A VRAM 134 is used as a temporary storage area of image data for display.

The photographing of a 3D image using the imaging device 1 is conducted in the following procedure. The solid state image sensor for the left eye L104 and the solid state image sensor for the right eye R104 photoelectrically convert lights passing through the imaging unit for a left eye L100 and the imaging unit for a right eye R100, thereby generating analog imaging signals for left and right subjects, respectively.

After analog signal processing units L105 and R105 amplify both of the analog imaging signals, A/D converters L106 and R106 convert the amplified signals into digital data. Image input controllers L107 and R107 fetch digital data output from the A/D converters L106 and R106 and store them in the SDRAM 133.

Digital signal processing units L108 and R108 fetch the digital data stored in the SDRAM 133 based on a command sent from the CPU 120, and carry out a predetermined signal processing to generate signals that includes a luminance signal and a color-difference signal. The digital signal processing units L108 and R108 also carry out various digital corrections including: an offset processing; a white balance adjustment processing; a gamma correction processing; an RGB complementation processing; a noise reduction processing; a contour correction processing; a color tone correction processing; a light source type decision processing; and the like.

A compression and stretching processing unit 135, a media control unit 136, an image processing unit 137, a card I/F 138 and an input/output I/F 140 are connected to the data bus 130.

The compression and stretching processing unit 135 carries out a compression processing in a predetermined format over the digital data stored in the SDRAM 133 to generate compressed image data in accordance with a command sent from the CPU 120. Moreover, a stretching processing in a predetermined format is carried out over compressed image data stored in a card type recording medium 139 or the like to generate non-compressed image data in accordance with a command sent from the CPU 120. In the imaging device 1 according to the present embodiment, a compressing method based on the MPEG standard or H.264/AVC is employed for a moving image and a compressing method based on the JPEG standard is employed for a static image.

The media control unit 136 controls to write data to the card type recording medium 139 or to read the data from the card type recording medium 139 through the card I/F 138 in accordance with a command sent from the CPU 120.

A liquid crystal monitor 141, the operating unit 142 and an input/output terminal 143 are connected to the input/output I/F 140.

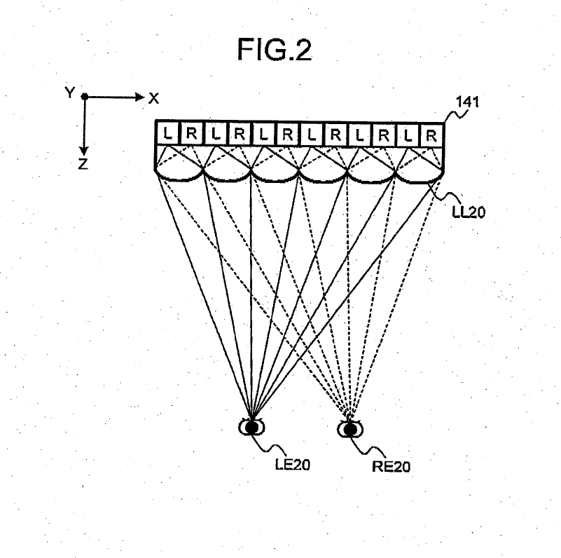

FIG. 2 is a view for explaining an example of a structure of the liquid crystal monitor 141 capable of displaying a 3D image. In FIG. 2, description will be given on the assumption that a horizontal direction is set to be an X axis, a vertical direction is set to be a Y axis, and an orthogonal direction of the liquid crystal monitor 141 is set to be a Z axis with respect to the liquid crystal monitor 141 in a normal using posture of the imaging device 1.

A lenticular lens LL20 provided between the liquid crystal monitor 141 and left and right eyes LE20 and RE20 of an observer. The lenticular lens LL20 is structured by connecting a plurality of cylindrical convex lenses in an X-axis direction of FIG. 2.

A display area for a 3D image to be displayed on the liquid crystal monitor 141 is structured by a strip image display area for a left eye L and a strip image display area for a right eye R. The strip image display area for a left eye L and the strip image display area for a right eye R take a shape of a slender strip in a Y-axis direction of FIG. 2 respectively and are disposed alternately in the X-axis direction.

Each of the convex lenses constituting the lenticular lens LL20 is formed in a corresponding position to each strip collecting image area including a set of strip image display areas for left and right eyes L and R based on a predetermined observation point of an observer.

A curvature of each convex lens constituting the lenticular lens LL20 or the like is set in such a manner that a strip image for the left eye displayed on the strip image display area for the left eye L of the liquid crystal monitor 141 is incident on the left eye LE20 of the observer, and a strip image for a right eye displayed on the strip image display area for a right eye R of the liquid crystal monitor 141 is incident on the right eye RE20 of the observer.

Accordingly, the left eye of the observer observes only the strip image for the left eye and the right eye observes only the strip image for the right eye. Consequently, an image photographed by the imaging device 1 can be perceived as a 3D image through the liquid crystal monitor 141.

Although the example of the case in which the lenticular method is used has been described as the structure of the liquid crystal monitor 141 for displaying the 3D image based on FIG. 2, the present invention is not limited to the lenticular method but it is also possible to employ different methods for displaying the 3D image, for example, a parallax barrier method, a light direction control method or the like.

The liquid crystal monitor 141 can display not only a photographic image in 3D, but also can display one of the image for the left eye or the image far the right eye in 2D. Moreover, both of the images for the left and right eyes can also be arranged and displayed in 2D by using what is called a side-by-side method.

The operating unit 142 includes: an operation key including a release switch and a power switch; a cross key; a joy stick; or a touch panel, which are not illustrated, superimposed on the liquid crystal monitor 141 or the like, and accepts an operation input to the imaging device 1 of a user.

The input/output terminal 143 is connected to a television monitor, a PC (Personal Computer) or the like which is not illustrated.

The image processing unit 137 carries out a predetermined image processing over a digital imaging signal read out from the SDRAM 133, for example. Upon receiving an instruction from the CPU 120, the image processing unit 137 generates image data for various processings, and superimposes the image data on original imaging data read from the SDRAM 133 and outputs them to the liquid crystal monitor 141. By the output, an image to be displayed on the liquid crystal monitor 141 has various image data synthesized therewith.

For example, there is generated a selection image for selecting any of an “automatic parallax adjusting mode”, a “manual parallax adjusting mode” and a “parallax adjustment non-executing mode” in the adjustment of the parallax between the photographic image for the left eye and the photographic image for the right eye by a user, an image indicative of a result of a face detection carried out by a face detecting unit 124, or the like which will be described below in detail. Then, the image processing unit 137 superimposes the screens on at least one of the image for the left eye and the image for the right eye and outputs them to the liquid crystal monitor 141.

The parallax determining unit 121 determines a parallax in a horizontal direction between the photographic image data for the left eye and the photographic image data for the right eye which are temporarily stored in the SDRAM 133. The parallax is determined in such a manner that a preset value is obtained or a parallax between subject images from which the face detecting unit 124 detects face image data or other subject images designated by the user is zero.

The parallax adjusting unit 122 adjusts the parallax between the photographic image data for the left eye and the photographic image data for the right eye in such a manner that the parallax determined by the parallax determining unit 121 is obtained by excluding at least a part of the image data in the horizontal direction as a parallax adjusting image from each of the photographic image data for the left eye and the photographic image data for the right eye which are temporarily stored in the SDRAM 133.

A photographic information recording unit 123 records zoom magnifications of the photographic image for the left eye and the photographic image for the right eye which are regulated by the zoom actuators L110 and R110 and a size of the parallax adjusting image used for adjusting the parallax between the photographic image data for the left eye and the photographic image data for the right eye through the parallax adjusting unit.

3D Image Photographing Processing for Adjusting Three-Dimensionality of Subject Image Corresponding to Zoom Magnification

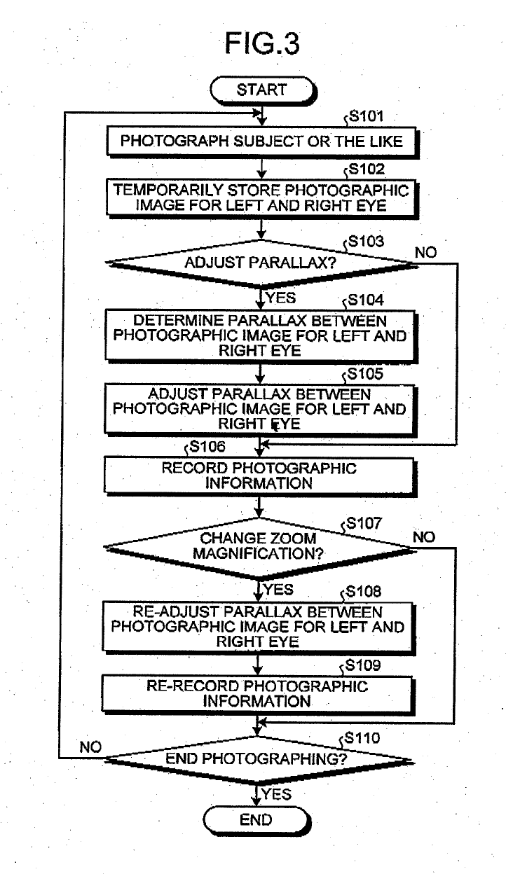

Description will be given to a processing (method) for photographing a 3D image which adjusts a three-dimensionality of a subject image corresponding to a zoom magnification through the imaging device 1. FIG. 3 is a flow chart for explaining a processing for photographing a 3D image which maintains a three-dimensionality intended before a change in the zoom magnification also after the change in the zoom change through the imaging device 1.

The present processing is executed in accordance with a program through an integrated control of the CPU 120 in FIG. 1 when a user pushes a picture recording button (not illustrated) of the operating unit 142. Moreover, it is also possible to start the present processing over a through image which is acquired when the user turns ON the imaging device 1 to select a photographing mode by using a button (not illustrated) of the operating unit 142 or the like or when a picture recording button is half-pushed.

As described above, after the zoom actuators L110 and R110 are driven so that a predetermined zoom magnification is set or in a state in which a zoom magnification set in the ON operation of the power supply is maintained, a landscape or a subject is photographed through the imaging system for a left eye L100 and the imaging system for a right eye R100 (Step S101).

Then, the landscape or subject thus photographed is temporarily recorded as photographic image data for the left eye and photographic image data for the right eye in the SDRAM 133 through the solid state imaging unit for a left eye L104 and the solid state imaging unit for a right eye R104 (Step S102). Herein, the photographic image data for the left eye and the photographic image data for the right eye which are temporarily stored are displayed on the liquid crystal monitor 141 through the input/output I/F.

Next, it is selected whether a parallax in a horizontal direction of the photographic image data for the left eye and the photographic image data for the right eye which are temporarily stored in the SDRAM 133 at the Step S102 is adjusted or not (Step S103).

For example, the flash ROM 132 records at least three modes, that is, an “automatic parallax adjusting mode” for adjusting the parallax in the horizontal direction by a predetermined magnitude, a “manual parallax adjusting mode” for manually determining a parallax between specific subjects by a user, and a “parallax adjustment non-executing mode” in which the parallax adjustment is not carried out, and processings corresponding to the respective modes.

The parallax determining unit 121 determines that the parallax is to be adjusted when the user selects the “automatic parallax adjusting mode” or the “manual parallax adjusting mode” or is selecting either of them, and determines that the parallax is not adjusted when the user selects the “parallax adjustment non-executing mode”.

If the parallax determining unit 121 determines that the parallax between the image data for the left eye and the image data for the right eye is to be adjusted at the Step S103 (YES in the Step S103), the parallax determining unit 121 determines the parallax between the image data for the left eye and the image data for the right eye which are recorded in the SDRAM 133 (Step S104), and the parallax adjusting unit 122 adjusts the parallax between the photographic image data for the left eye and the photographic image data for the right eye based on the parallax determined by the parallax determining unit 121 (Step S105). The processings for determining and adjusting the parallax are carried out in the following manner in each of the “automatic parallax adjusting mode” and the “manual parallax adjusting mode”, for example.

Adjustment of Parallax in Automatic Parallax Adjusting Mode

If a user selects the “automatic parallax adjusting mode”, the parallax determining unit 121 determines a parallax having a predetermined magnitude as the parallax between the photographic image data for the left eye and the photographic image data for the right eye. The predetermined magnitude of the parallax may have a fixed value or may have an average value of the parallaxes of respective whole images of the image data for the left eye and the image data for the right eye.

The parallax determining unit 121 calculates a difference vector between each subject image data of the photographic image data for the left eye and each subject image data of the photographic image data for the right eye to determine the parallax between the photographic image data for the left eye and the photographic image data for the right eye by a technique which applies an algorithm for specifying an amount of movement of the same subject in MPEG between frames, for example, calculating a so-called motion vector, and thus determines the parallax between the photographic image data for the left eye and the photographic image data for the right eye.

In the MPEG which is a moving picture compressing technique, an algorithm for detecting a motion vector based on block matching is used. The motion vector expresses, in a vector, a displacement of the same subject between two frame data. Current frame data and past frame data are compared with each other and the most similar block having the same size is extracted from each of them, and the motion vector is calculated based on a positional relationship between both of them.

By utilizing the algorithm for calculating the motion vector, the parallax determining unit 121 specifies the same subject image data in the photographic image data for the left eye and the photographic image data for the right eye, extracts a point corresponding in point-versus-point or pixel-versus-pixel for the same subject image data from the photographic image data for the left eye and the photographic image data for the right eye, and calculates their difference vector as a parallax between the subject image data in the photographic image data for the left eye and the photographic image data for the right eye.

The parallax determining unit 121 calculates a vector to be an average of all of the difference vectors calculated as described above, and determines a parallax between the photographic image data for the left eye and the photographic image data for the right eye in such a manner that the subject image having the greatest difference vector has the average difference vector thus calculated.

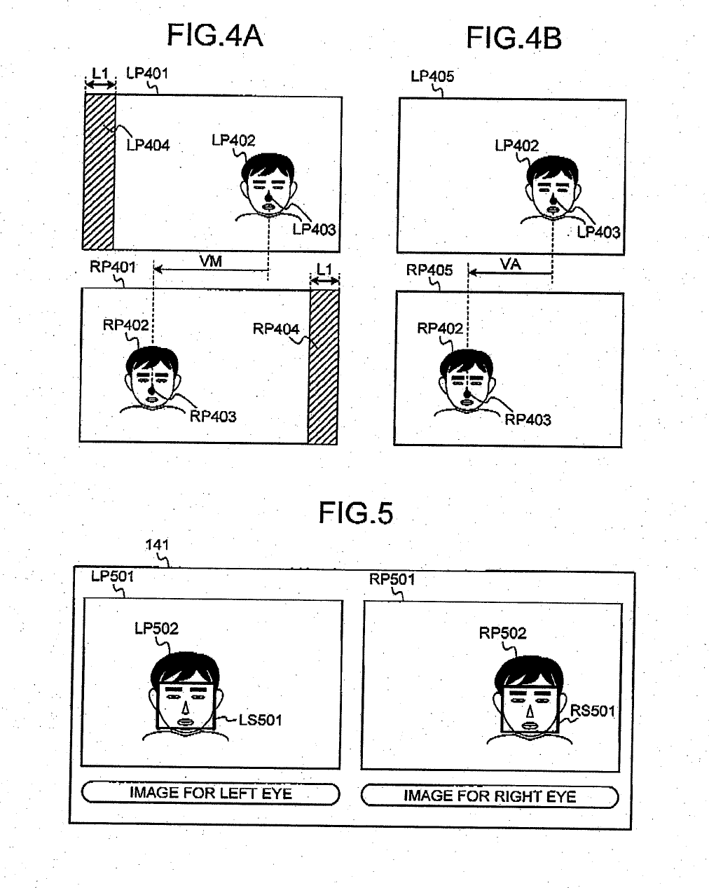

When the parallax determining unit 121 determines the parallax between the photographic image data for the left eye and the photographic image data for the right eye as described above, the parallax adjusting unit 122 determines an area of a parallax adjusting image based on each of the photographic image data for the left eye and the photographic image data for the right eye. FIGS. 4A and 4B are conceptual views illustrating the processing.

FIG. 4A illustrates, as an example, the case in which a difference vector VM between a reference point LP403 of subject image data LP402 in photographic image data for a left eye LP401 and a corresponding point RP403 of subject image data RP402 in photographic image data for a right eye RP401 is calculated as the greatest difference vector VM by the technique described above, and an average of all of the difference vectors between the photographic image data for the left eye LP401 and the photographic image data for the right eye RP401 is calculated as VA.

The parallax determining unit 121 calculates L1 in accordance with the following equation (1) and determines areas, that is, parallax adjusting image data LP404 to be excluded from the photographic image data for a left eye LP401 (an area illustrated in hatching in FIG. 4A) and parallax adjusting image data RP404 to be excluded from the photographic image data for a right eye RP401 (an area illustrated in hatching in FIG. 4A).

L1=|VM−VA|/2 (1)

As described above, the parallax adjusting unit 122 determines the parallax adjusting image data LP404 and RP404, and generates, as new photographic image data, photographic image data for a left eye LP405 obtained by excluding the parallax adjusting image data L404 from the photographic image data for the left eye LP401 and photographic image data for the right eye RP405 obtained by excluding the parallax adjusting image data RP404 from the image data for a right eye RP401 as illustrated in FIG. 4B. Consequently, subject images LP402 and RP402 have a parallax which is equivalent to the average difference vector VA.

As described above; by adjusting a parallax in such a manner that a subject image having a parallax to be the greatest difference vector has a parallax to be an average difference vector in the “automatic parallax adjusting mode”, it is possible to properly adjust a parallax between images having a possibility that a three-dimensionality to be perceived might be excessively increased due to an excessively large parallax and a burden might be imposed on an observer.

Adjustment of Parallax in Manual Parallax Adjusting Mode

In the case in which a user selects the “manual parallax adjusting mode”, the parallax determining unit 121 determines the parallax between the photographic image data for the left eye and the photographic image data for the right eye in such a manner that a parallax between optional subject images designated by the user is zero, for example. The subject image is designated by the user through a technique utilizing a detection of a face image of a subject as will be described below, for example.

First of all, the face detecting unit 124 detects face image data from the photographic image data for the left eye and the photographic image data for the right eye. The face image data is detected by using a well-known technique based on characteristics of the face image. For example, there is employed a method of detecting a face image through the processing described in Japanese Laid-open Patent Publication No. 2001-16573 or the like. As the characteristics, for example, there is used each end point of an eyebrow, an eye, a nose or a lip, a contour point of a face, a peak of a face, a lower end point of a jaw or the like. The algorithm to be used for detecting the face image data by the face detecting unit 124 is not limited to the above-mentioned algorithm but an optional algorithm can be used.

FIG. 5 illustrates an example of a display manner of the liquid crystal monitor 141 in the case in which the face image data is detected. The liquid crystal monitor 141 displays image data for a left eye LP501 and image data for a right eye RP501 side by side as illustrated in FIG. 5.

A person image LP502 is displayed in the image data for a left eye LP501, and a person image RP502 is displayed in the image data or a right eye RP501. Graphic images LS501 and RS501 generated by the image processing unit 137 are superimposed and displayed in the vicinity of the face images detected in the person images LP502 and RP502.

Next, the user touches one of the graphic images LS501 and RS501 through a touch panel (not illustrated) of the operating unit 142 provided on the liquid crystal monitor 141, thereby designating that a parallax between the person images LP502 and RP502 is set to be zero. Even if the user does not carry out the designation, the imaging device 1 can automatically set the parallax between subject images from which a face image is detected to zero.

When there is designated that the parallax between the person images LP502 and RP502 is set to be zero, the parallax determining unit 121 first calculates a parallax between the person images LP502 and RP502 in the following manner.

The parallax determining unit 121 calculates central coordinates of the face images of the subject images LP502 and RP502 by a well-known method. For example, the method described in Japanese Laid-open Patent Publication No. 2000-339476 or the like is employed.

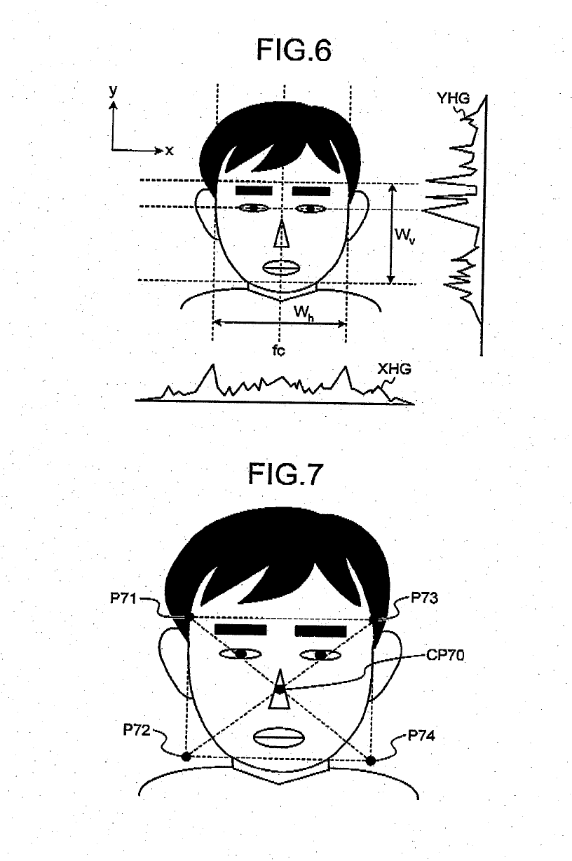

In other words, as illustrated in FIG. 6, the parallax determining unit 121 first specifies a center line fc of a face image which is detected. The center line fc is specified by obtaining x coordinates having a high symmetry of left and right pixel values in the face image.

When the center line of the face image is specified, x-direction edge information and y-direction edge information which highlight edges in x and y directions are calculated from a shade of the face image. A calculating unit first carries out a projecting addition processing over the x-direction edge information in the x direction to obtain an x-direction edge projection histogram XHG.

In the case of the face image, the edge in the x direction usually appears often in a contour portion of a face. The parallax determining unit 121 searches for a part having a great value of the x-direction edge projection histogram XHG in a transverse direction from the center line of the face, thereby determining a width Wₕ of an area of the face image.

When the width Wₕ is determined, the y-direction edge information is subjected to the projecting addition processing in the y direction to obtain a y-direction edge projection histogram YHG. In the case in which a length of the face is determined, a y coordinate candidate position of an eye is detected to determine a length Wᵥ of an area of a face image from the y coordinate candidate of the eye and a lateral edge projection histogram HHG by utilizing the fact that the y direction edge intensively appears in the vicinity of the eye and rarely appears in a portion of a lower cheek.

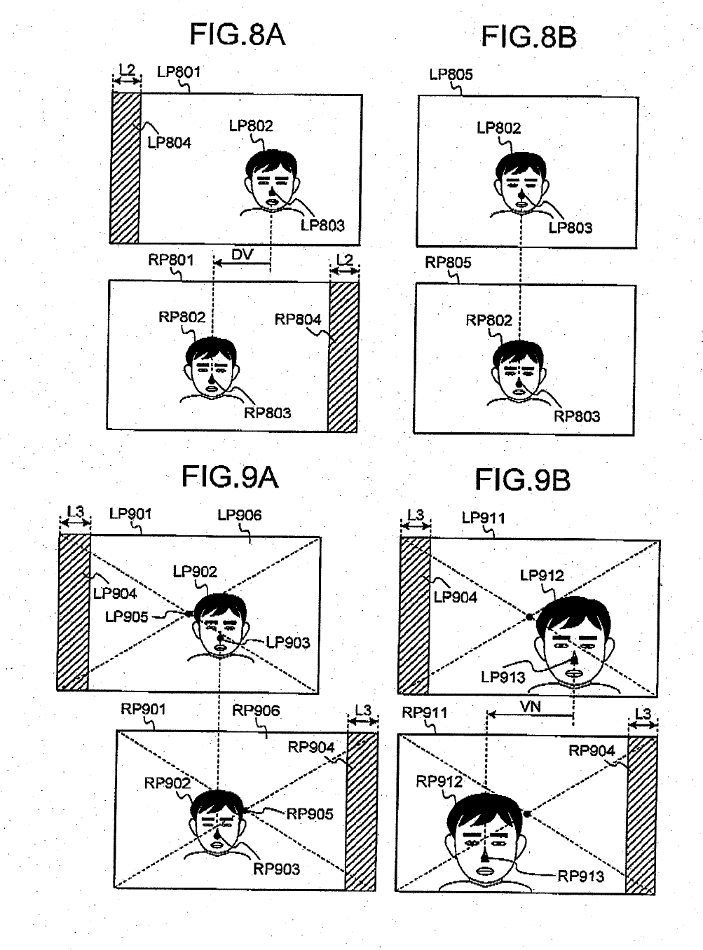

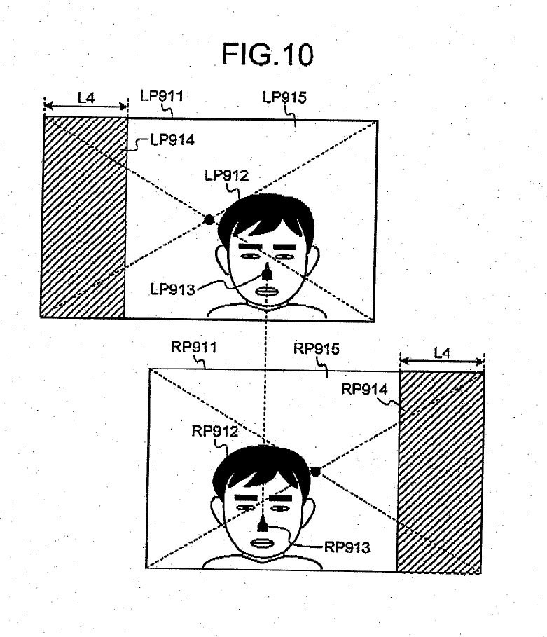

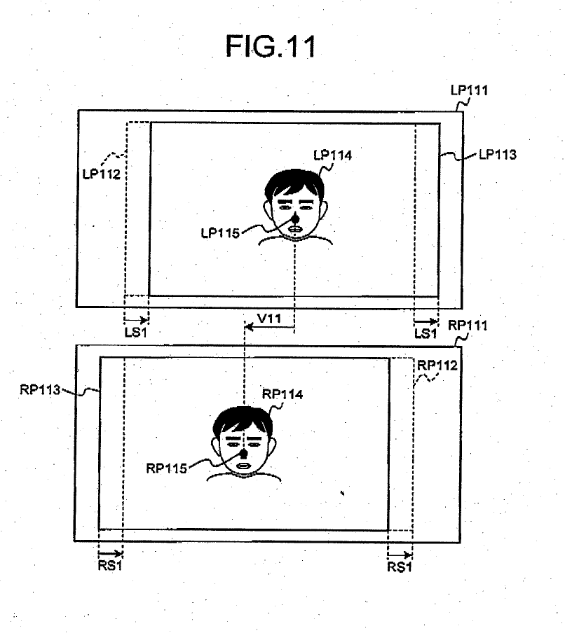

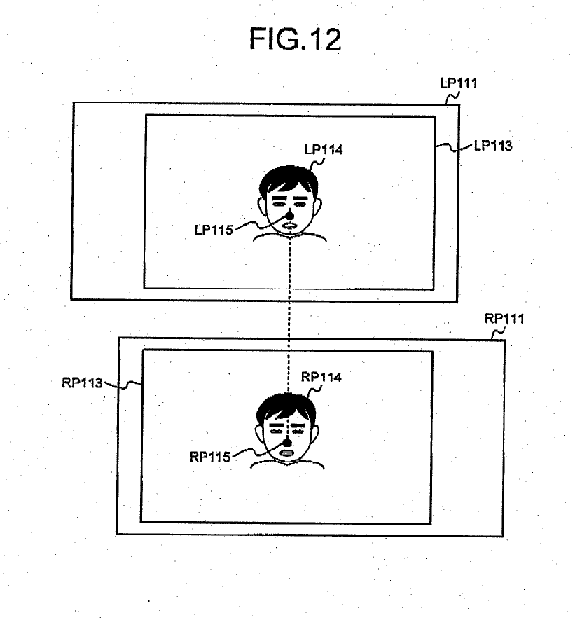

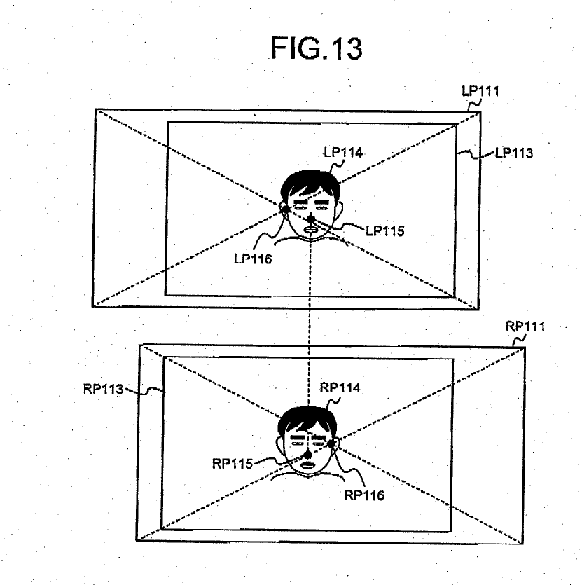

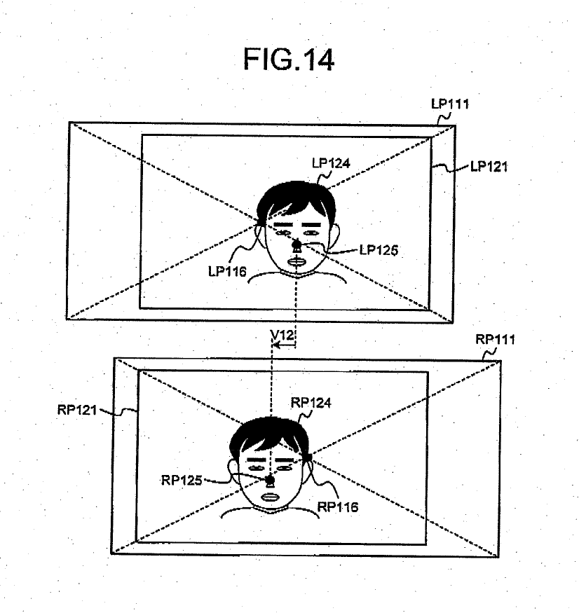

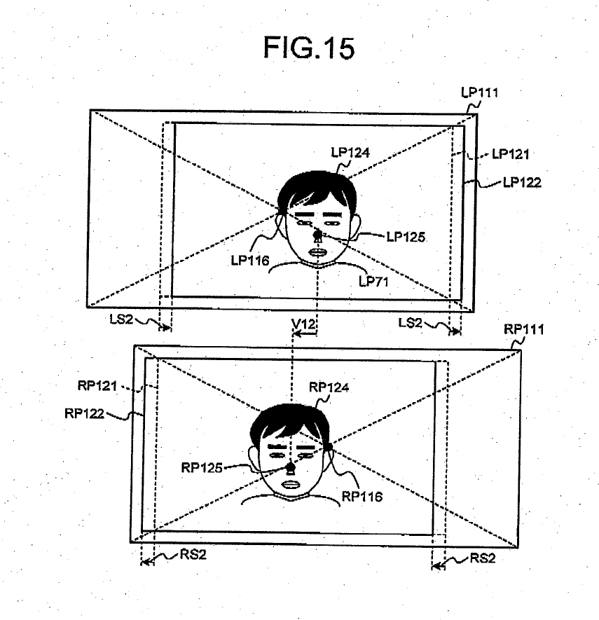

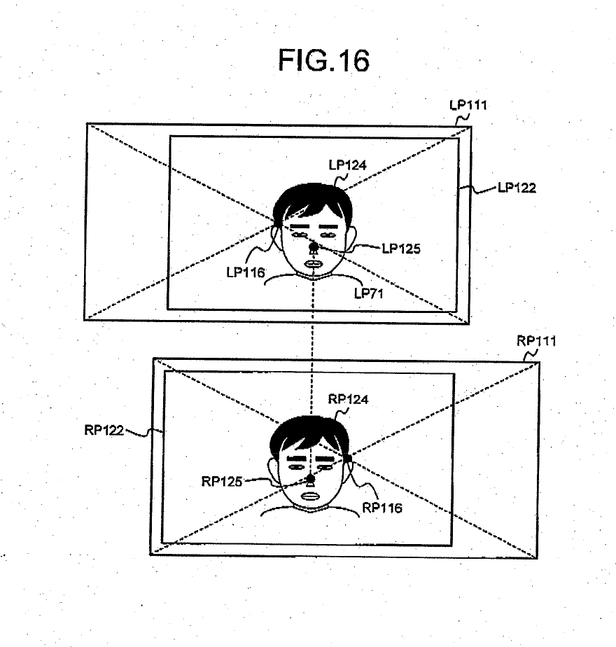

As described above, the parallax determining unit 121 specifies the area of the face image. Then, the parallax determining unit 121 calculates coordinates of four vertexes P71, P72, P73 and P74 in the area of the face image as illustrated in FIG. 7, thereby obtaining center coordinates CP70 in the area of the face image from the four vertex coordinates. The center coordinates of the face image in the image for the left eye are set to be a reference point and center coordinates of the face image in the image for the right eye are set to be a corresponding point.

The center coordinates of the face image in the image for a right eye may be set to be the reference point and the center coordinates of the face image in the image for the left eye may be set to be the corresponding point. Moreover, the area of the face image may be specified by using another well-known algorithm in addition to the algorithm described above.

The parallax determining unit 121 calculates a parallax between subject images designated by the user from the reference point and the corresponding point which are calculated as described above, and determines the parallax between the photographic image data for the left eye and the photographic image data for the right eye in such a manner that the parallax is set to be zero.

When the parallax determining unit 121 determines the parallax between the photographic image data for the left eye and the photographic image data for the right eye as described above, the parallax adjusting unit 122 determines an area of a parallax adjusting image from each of the photographic image data for the left eye and the photographic image data for the right eye. FIGS. 8A and 8B are conceptual views illustrating the processing.

As illustrated in FIG. 8A, the parallax determining unit 121 calculates a difference vector DV between a reference point LP803 of subject image data LP802 in photographic image data for a left eye LP801 and a corresponding point RP803 of subject image data RP802 in photographic image data for aright eye RP801.

When the parallax is set to be zero is determined, the parallax adjusting unit 122 determines, as an image area having a length in a horizontal direction calculated from the following equation (2), each of areas, that is, parallax adjusting image data LP804 (an area illustrated in hatching in FIG. 8A) to be excluded from the photographic image data for a left eye LP801 and parallax adjusting image data RP804 (an area illustrated in hatching in FIG. 8A) to be excluded from the photographic image data for a right eye RP801.

L2=|DV|/2 (2)

As described above, the parallax adjusting unit 122 determines the parallax adjusting image data L804 and R804 to generate, as new photographic image data, LP805 obtained by excluding the parallax adjusting image data L804 from the photographic image data for a left eye LP801 and RP805 obtained by excluding the parallax adjusting image data LP804 from the image data for a right eye LP801 as illustrated in FIG. 8B. Consequently, the parallax between the subject images LP802 and RP802 is zero.

As described above, in the “manual parallax adjusting mode”, a user can generate a 3D image having a favorite three-dimensionality by designating a subject image having a parallax of zero.

In the imaging device 1, it is assumed that a parallax of a subject designated by the user can be set not only to zero but also to a preset value.

Returning to FIG. 3, when the parallax between the photographic image data for the left eye and the photographic image data for the right eye is adjusted at the Step S105, the photographic information recording unit 123 records, as photographic information, the magnifications of the zoom lenses L101 and R101 in the adjustment of the parallax and a size of the parallax adjusting image data (Step S106).

If there is determined that the parallax between the photographic image data for the left eye and the photographic image data for the right eye is not adjusted at the Step S103 (NO in the Step S103), the photographic information recording unit 123 records that the magnifications of the lenses L101 and R101 and the size of the parallax adjusting image are zero in the generation of the photographic image data for the left eye and the photographic image data for the right eye which are recorded in the SDRAM 133 at the Step S102.

If the user drives the zoom actuators L110 and R110 to change the zoom magnification in the photographing (YES in the Step S107), next, the parallax adjusting unit 122 changes the size of the parallax adjusting image data in the photographic image data for the left eye and the photographic image data for the right eye which are recorded in the SDRAM 133, thereby readjusting the parallax between the photographic image for the left eye and the photographic image for the right eye (Step S108).

FIGS. 9A and 93 are conceptual views for explaining a problem in the case in which the parallax adjusting image data is excluded from the photographic image data for the left eye and the photographic image data for the right eye which are recorded in the SDRAM 133 and the zoom magnification is then changed.

FIG. 9A is a view illustrating the case in which the zoom magnification is set to be one, parallax adjusting image data LP904 (an area illustrated in hatching in FIG. 9A) is excluded from photographic image data for a left eye LP901 and parallax adjusting image data RP904 (an area illustrated in hatching in FIG. 9A) is excluded from photographic image data for a right eye RP901 by the parallax adjusting unit 122, and an adjustment is carried out in such a manner that a parallax between subject image data LP902 and subject image data RP902 is zero.

Herein, photographic image data for a left eye LP906 obtained by excluding the parallax adjusting image data L904 from the photographic image data for a left eye LP901 and photographic image data for a right eye RP906 obtained by excluding the parallax adjusting image data RP904 from the image data for a right eye RP901 are generated as new photographic image data.

When the photographic image data for the left eye and the photographic image data for the right eye are set into the state in FIG. 9A, a reference point LP903 in the photographic image data for a left eye LP901 and a corresponding point RP903 in the photographic image, data for a right eye RP901 are coincident with each other in a 3D image and a parallax is zero in a position in which these two points overlap with each other. In other words, the user quasi-recognizes an optical axis of the photographic image for the left eye and that of the photographic image for the right eye as if they were crossed each other in this position.

On the other hand, when the zoom actuators L110 and R110 are driven to change the zoom magnification, the magnification is changed around centers LP905 and RP905 of the photographic image data for a left eye LP901 and the photographic image data for a right eye RP901 which are temporarily stored in the SDRAM 133 at the Step S102. The reason is that images of the centers of the optical axes AL100 and AR100 in the imaging systems L100 and R100 are formed on the LP905 and the RP905, respectively.

As described above, in the case in which a reading area in a horizontal direction of image data transmitted from memory is changed, the optical axis of the lens of the imaging system is not coincident with the optical axis quasi-recognized for a photographic image read from the memory.

Accordingly, in the case in which the zoom magnification is 1.5-fold changed as illustrated in FIG. 9B, for example, photographic image data for a left eye LP911 obtained by 1.5-fold enlarging the photographic image data for a left eye LP901 and photographic image data for a right eye RP911 obtained by 1.5-fold enlarging the photographic image data for a right eye RP901 in FIG. 9A are generated around the center of the photographic image data recorded in the SDRAM 133, respectively.

A subject image LP912 obtained by 1.5-fold enlarging the subject image LP902 and a subject image RP912 obtained by 1.5-fold enlarging the subject image RP902 in FIGS. 9A and 9B are generated, and a parallax VN is generated again between a reference point LP913 of the subject image LP912 and a corresponding point RP913 of the subject image RP912.

Consequently, the parallax adjusting image is once secured in the photographic image data to adjust the parallax. Even if the parallax adjustment is carried out in such a manner that a parallax of an optional subject image is zero, the parallax is generated in the subject image again due to the change in the zoom magnification so that the position having the parallax of zero is moved to another place.

Accordingly, a three-dimensionality of a 3D image obtained after the change in the zoom magnification is different from that of a 3D image intended by the user before the change. This is true in all of the cases in which the parallax is adjusted by excluding the parallax adjusting image from the photographic image data for the left eye and the photographic image data for the right eye which are stored in the SDRAM 133. This is because the parallax adjusting image is excluded so that a position of a center of each photographic image data which acts as a center of a zoom and a position in which the parallax is zero are shifted from each other.

In the case in which the zoom magnification is changed, therefore, the parallax adjusting unit 122 changes a size of a parallax adjusting image to be excluded from the photographic image data depending on the change in the zoom magnification. FIG. 10 is a conceptual view for explaining this processing. The parallax adjusting unit 122 determines sizes of a parallax adjusting image LP914 (an area illustrated in hatching in FIG. 10) to be excluded from photographic image data for a left eye LP911 and a parallax adjusting image RP914 (an area illustrated in hatching in FIG. 10) to be excluded from photographic image data for a right eye RP911 which are calculated in accordance with the following equation (3), wherein the zoom magnification before the change is represented by ZD1 and the zoom magnification after the change is represented by ZD2.

L4=L3×ZD2/ZD1 (3)

Then, as illustrated in FIG. 10, the photographic image data for a left eye LP915 obtained by excluding the newly determined parallax adjusting image data LP914 from the photographic image data for a left eye LP911 and photographic image data for a right eye RP915 obtained by excluding the newly determined parallax adjusting image data RP914 from the image data for a right eye RP911 are generated as new photographic image data. Consequently, the parallax between the subject images LP912 and RP912 is maintained to be zero.

As described above, the parallax adjusting unit 122 changes the size of the parallax adjusting image depending on the change in the magnifications of the zoom lenses L101 and R101. Therefore, an image of a subject having a parallax of zero is not changed but a user can acquire a 3D image having a three-dimensionality intended before changing the zoom magnification also after the change in the zoom magnification.

When the parallax adjusting unit 122 readjusts the parallax between the photographic image data for the left eye and the photographic image data for the right eye at Step S108, the photographic information recording unit 123 re-records the magnifications of the zoom lenses L101 and R101 in the adjustment of the parallax and the size of the parallax adjusting image (Step S109).

The processing for recording the photographic information is carried out in the same manner as in the Step S106. When the user drives the zoom actuators L110 and R110 to change the zoom magnification, information about the changed zoom magnification is recorded in the photographic information recording unit 123 at each time so that the processing is executed. In the imaging device 1, accordingly, the parallax can be adjusted in accordance with the past change including a zoom magnification set finally by the user.

When the photographic information is completely re-recorded at the Step S109 or the user does not change the zoom magnification (NO in the Step S107), thereafter, the photographing operation is ended in accordance with a program through the integrated control of the CPU 120 in FIG. 1 if the user releases a picture recording button (not illustrated) of the operating unit 142 (YES in step S110).

When the user turns OFF the imaging device 1 to cancel the photographing mode by using a button (not illustrated) of the operating unit 142 or the like or releases the picture recording button which is half-pushed, alternatively, it is also possible to and the present processing for a through image which has been acquired. If the user does not end the photographing operation (NO in the Step S109), the same processing is repeated from the Step S101.

As described above, according to the imaging device 1 in accordance with the present invention, also in the case in which the zoom magnification is changed after the slicing area from the memory is regulated to adjust the parallax between the image data for the left eye and the image data for the right eye, it is possible to generate a 3D image maintaining a three-dimensionality intended before the change in the zoom magnification also after the change in the zoom magnification by changing the slicing area of the image data for the left eye and the image data for the right eye following the change in the zoom magnification.

In the description, the photographic image data generated at each time is recorded in the card type recording medium 139 or is output to the liquid crystal monitor 141 from the SDRAM 133 through the data bus 130 or the like. Although the description has been given by assuming the processing in the photographic image data for the left eye and the photographic image data for the right eye which are temporarily stored in the SDRAM 133, moreover, it is possible to obtain the same effects even if the processing is executed over other memory or image sensors.

The description has been given to that the parallax adjusting unit 122 excludes the parallax adjusting image data to adjust the parallax between the photographic image data for the left eye and the photographic image data for the right eye when the imaging device 1 according to the embodiment of the present invention executes the processing for photographing a 3D image to adjust the three-dimensionality of a subject image corresponding to the zoom magnification.

From another aspect, the parallax adjustment can be described as a processing for causing the parallax adjusting unit 122 to specify an image output area of new photographic image data subjected to the parallax adjustment at each time from the photographic image data for the left eye and the photographic image data for the right eye which are temporarily stored in the SDRAM 133. In other words, data related to an image area obtained by excluding the parallax adjusting image data from the photographic image data for left and right eyes is specified as a new image output area for the photographic image data.

The processing for photographing a 3D image to adjust a three-dimensionality of a subject image corresponding to a zoom magnification by the imaging device 1 according to the embodiment of the present invention will be described with reference to FIGS. 1 and 3 in combination of the explanation of the parallax adjustment grasped from a specific aspect of the image output area.

As described above, the present processing is executed in accordance with the program through the integrated control of the CPU 120 in FIG. 1 when a user pushes the picture recording button (not illustrated) of the operating unit 142. Moreover, the present processing may be started for a through image to be acquired when the user turns ON the imaging device 1 to select the photographing mode by using a button (not illustrated) of the operating unit 142 or the like or when the picture recording button is half-pushed.

As described above, a landscape or a subject is photographed through the imaging system for a left eye L100 and the imaging system for a right eye R100 after the zoom actuators L110 and R110 are driven so that a predetermined zoom magnification is set or in a state in which the zoom magnification set in the ON operation of the power supply is maintained at the Step S101 of FIG. 3.

The landscape or subject thus photographed is temporarily recorded as the photographic image data for the left eye and the photographic image data for the right eye in the SDRAM 133 through the solid state image sensor for a left eye L104 and the solid state image sensor for a right eye R104 (Step S102). Herein, image data corresponding to a predetermined area in the photographic image data for the left eye and the photographic image data for the right eye which are temporarily stored are output as an image output area to the card I/F 138 or the input/output I/F 140.

At the Step S102, next, it is selected whether a parallax in a horizontal direction between the photographic image data for the left eye and the photographic image data for the right eye which are temporarily stored in the SDRAM 133 is to be adjusted or not (Step S103).

If the parallax determining unit 121 determines that the parallax between the image data for the left eye and the image data for the right eye is to be adjusted at the Step S103 (YES in the Step S103), it determines the parallax between the image data for the left eye and the image data for the right eye which are recorded in the SDRAM 133 (Step S104) and the parallax adjusting, unit 122 adjusts the parallax between the photographic image data for the left eye and the photographic image data for the right eye based on the parallax determined by the parallax determining unit 121 (Step S105). The processing for determining and adjusting the parallax is executed as described above in each of the “automatic parallax adjusting mode” and the “manual parallax adjusting mode”.

From a different aspect from that described above, explanation will be given to the determination of the parallax in the horizontal direction through the parallax determining unit 121 and the adjustment of the parallax in the horizontal direction of the parallax adjusting unit 122 with reference to FIG. 11.

FIG. 11 is a conceptual view for explaining a parallax adjustment for setting, to be zero, a parallax in a horizontal direction between subject image data LP114 and subject image data RP114 from which the face detecting unit 124 detects face image data as an example of the adjustment of the parallax in the horizontal direction through the parallax adjusting unit 122.

In FIG. 11, photographic image data for a left eye LP112 (an area illustrated in a broken line in FIG. 11) and photographic image data for a right eye RP112 (an area illustrated in a broken line in FIG. 11) are specified as an output image area to be output to the card I/F 138 or the input/output I/F 140 from photographic image data for a left eye LP111 and photographic image data for a right eye RP111 which are temporarily stored in the SDRAM 133 at the Step S102.

In FIG. 11, moreover, the parallax determining unit 121 calculates, as a parallax, a difference vector V11 between a reference point LP115 in the photographic image data for a left eye LP112 and a corresponding point RP115 in the photographic image data for a right eye RP112.

The parallax determining unit 121 determines a direction and a size of a shift of an image area for specifying a new image output area from the photographic image data for a left eye LP112 specified as an image output area at present in the photographic image data for a left eye LP111 which is temporarily stored at the Step S102 based on a direction and a size of the difference vector V11 which is calculated.

Similarly, the parallax determining unit 121 determines a direction and a size of a shift of an image area for specifying a new image output area from the photographic image data for a right eye RP112 specified as an image output area at present in the photographic image data for a right eye RP111 which is temporarily stored at the Step S102 based on the direction and the size of the difference vector V11 which is calculated.

Then, the parallax adjusting unit 122 shifts the image output areas to be output from the image data for the left eye and the image data for the right eye in accordance with the direction and the size for shifting the image area which are determined by the parallax determining unit 121, thereby specifying photographic image data related to a new output image area.

In FIG. 11, the parallax adjusting unit 122 specifies, as photographic image data for a left eye LP113 related to a new output image area, an area obtained by shifting a position of the photographic image data for a left eye LP112 before the parallax adjustment (an area illustrated in the broken line in FIGS. 9A and 9B) by LS1 which is a half of a difference vector V01 in an opposite direction to the difference vector V11 in the imaging data for a left eye LP111.

Moreover, the parallax adjusting unit 122 specifies, as imaging data for a right eye RP113 related to a new output image area, an area obtained by shifting a position of the imaging data for a right eye RP112 before the parallax adjustment (an area illustrated in the broken line in FIGS. 9A and 9B) by RS1 which is a half of the difference vector V01 in the direction of the difference vector V11 in the imaging data for a right eye RP111.

It is apparent that a difference area between the image output area before the shift and the image output area after the shift is excluded as the parallax adjusting area.

As described above, the parallax adjusting unit 122 shifts, in the horizontal direction, the positions of the photographic image data for the left eye related to the image output area extracted from the photographic image data for the left eye and the photographic image data for the right eye related to the image output area extracted from the photographic image data for a right eye and specifies a position of a new image output area, thereby adjusting the parallax in the horizontal direction.

In FIG. 11, the parallax between the subject image data LP114 in the output image data for a left eye LP113 and the subject image data RP114 in the output image data for a right eye RP113 is caused to be zero by the parallax adjustment.

FIG. 12 illustrates the photographic image data for a left eye LP113 related to a new output image area and the photographic image data for a right eye RP113 related to a new output image area which are obtained after the parallax in the horizontal direction between the subject image data LP114 and RP114 from which the face detecting unit 124 detects face image data is adjusted to be zero.

As illustrated in FIG. 12, the parallax between the reference point LP115 in the photographic image data for a left eye LP113 and the corresponding point RP115 in the photographic image data for a right eye RP113 is zero. When these photographic image data are output so that an image related to the image data is displayed on the liquid crystal monitor 141 or the like, the subject image is perceived by an observer as if it were exactly present on the monitor.

FIG. 11 illustrates the case in which the parallax is adjusted to perceive the subject image as if it were exactly present on a display surface when the subject image is perceived as if it were protruded from the display surface. To the contrary, referring to the case in which the parallax is adjusted to perceive the subject image as if it were exactly present on the display surface when the subject image is perceived as if it were recessed from the display surface, the photographic image data for the left eye related to the image output area is shifted in the direction of the difference vector and the photographic image data for the right eye related to the image output area is shifted in an opposite direction to the direction of the difference vector.

Returning to FIG. 3, when the parallax between the photographic image data for the left eye and the photographic image data for the right eye is adjusted at the Step S105, the photographic information recording unit 123 records, as photographic information, the magnifications of the zoom lenses L101 and R101 in the adjustment of the parallax and the position of the image output area specified at the Step S105 (Step S106).

If the parallax between the photographic image data for the left eye and the photographic image data for the right eye is determined to be non-adjusted at the Step S103 (NO in the Step S103), the photographic information recording unit 123 records the magnifications of the lenses L101 and R101 and the shift of the image output area is zero in the generation of the photographic image data for the left eye and the photographic image data for the right eye which are recorded in the SDRAM 133 at the Step S102.

If the user drives the zoom actuators L110 and R110 to change the zoom magnification in the photographing operation (YES in the Step S107), next, the parallax adjusting unit 122 changes the positions of the image output areas in the photographic image data for the left eye and the photographic image data for the right eye which are recorded in the SDRAM 133, and readjusts the parallax between the photographic image for the left eye and the photographic image for the right eye (Step S108).

Before description of the parallax adjustment corresponding to the change in the zoom magnification in the photographing operation, a problem caused in the case in which the parallax adjusting unit 122 adjusts the parallax between the photographic image for the left eye and the photographic image for the right eye and the zoom magnification is then changed will be explained below with reference to FIGS. 13 and 14.

FIG. 13 is a conceptual view illustrating relationships between the photographic image data for a left eye LP113 related to the image output area and the photographic image data for a right eye RP113 related to the image output area and between the optical axis AL100 of the imaging unit for a left eye L100 and the optical axis AR100 of the imaging unit for a right eye R110 which are obtained after the parallax is adjusted by the parallax adjusting unit 122.

As illustrated in FIG. 13, a position of each image output area is specified in such a manner that the parallax between the reference point LP115 of the photographic image data for a left eye LP113 and the corresponding point RP115 of the photographic data for a right eye RP113 is set to be zero by the parallax adjusting unit 122.

When the photographic image data for a left eye LP113 and the photographic image data for a right eye RP113 are set into the state of FIG. 13, the reference point LP115 in the photographic image data for a left eye LP113 and the corresponding point RP115 in the photographic image data for a right eye RP113 are coincident with each other in a 3D image displayed on a liquid crystal monitor 305 or the like, and the parallax is zero in a position in which these two points overlap with each other. In other words, the user quasi-recognizes an optical axis of the photographic image for the left eye and that of the photographic image for the right eye as if they crossed each other in this position.

On the other hand, when the zoom actuators L110 and R110 are driven to change the zoom magnification, the magnification is changed around the center LP116 of the photographic image data for a left eye LP111 and the center RP115 of the photographic image data for a right eye RP111 which are temporarily stored in the SDRAM 133. This is because an image of the optical axis AL100 of the imaging unit for a left eye L100 is formed in a position of the LP116 and an image of the optical axis AR100 of the imaging unit for a right eye R100 is formed in a position of the RP116.

As described above, in the case in which a reading area in a horizontal direction of image data transmitted from memory is changed, the optical axis of the lens of the imaging system is not coincident with the optical axis quasi-recognized for a photographic image read from the memory.

When an optical zoom magnification is changed to enlarge a photographic image, a subject image is enlarged centering a position which is coincident with the optical axis of the imaging unit in the photographic image data.

FIG. 14 is a view for explaining imaging data in the case in which a subject image subjected to a parallax adjustment to obtain a parallax of zero is enlarged by an optical zoom.

In the case in which the optical zoom magnification is changed to enlarge the photographic image as illustrated in FIG. 14, the photographic image data LP121 having subject image data LP124 obtained by enlarging the subject image data LP114 in FIG. 13 centering LP116 in the imaging data for a left eye LP111 is generated.

Similarly, the photographic image data RP121 having subject image data RP124 obtained by enlarging the subject image data RP114 in FIG. 13 centering RP116 in the imaging data for a right eye RP111 is generated.

A parallax V12 is generated between a reference point LP125 of the subject image data LP124 corresponding to the reference point LP115 of the subject image data LP114 and a corresponding point RP125 of the subject image data RP124 corresponding to the corresponding point RP115 of the subject image data RP114.

Consequently, the positions of the photographic image data for the left eye related to the image output area extracted from the photographic image data for the left eye and the photographic image data for the right eye related to the image output area extracted from the photographic image data for the right eye are regulated to adjust the parallax. Even if the parallax is adjusted in such a manner that a parallax between optional subject images is zero, the parallax is generated on the subject image again due to the change in the optical zoom magnification. As a result, a problem in that a convergent position having a parallax of zero is moved to another place is caused.

Returning to FIG. 3, if the zoom magnification is changed, the parallax adjusting unit 122 gradually increases the amounts of shift of the photographic image data for left and right eyes related to the image output area which is extracted depending on the change in the zoom magnification. Consequently, the parallax between the photographic image for the left eye and the photographic image for the right eye is readjusted (Step S108).

With reference to FIG. 15, description will be given to the readjustment of the parallax following the change in the zoom magnification when the zoom magnification is changed after the execution of the parallax adjustment.

FIG. 15 illustrates that a difference vector V12 is generated between the reference point LP125 of the subject image data LP124 in the photographic data for a left eye LP121 and the corresponding point RP125 of the subject image data RP124 in the photographic data for a right eye RP121 through the change in the optical zoom magnification.

A total shift amount S2 for setting a position corresponding to a convergent position before the change in the optical zoom magnification to be the convergent position also after the change in the optical zoom magnification is calculated in accordance with the following equation (4): wherein the optical zoom magnification in the parallax adjustment is represented by ZD3, the optical zoom magnification after the parallax adjustment is represented by ZD4 and a shift amount of the output image data before the change in the optical zoom magnification is represented by S1.

S2=S1×ZD4/ZD3 (4)

In FIG. 15, accordingly, a position of the photographic image data for a left eye LP122 which is obtained by shifting the photographic image data for a left eye LP121 (an area illustrated in a broken line in FIG. 15) by LS2 in an opposite direction to the difference vector and a position of the photographic image data for aright eye RP122 which is obtained by shifting the photographic image data for a right eye RP121 (an area illustrated in a broken line in FIG. 15) by RS2 in the direction of the difference vector are specified as new image output areas respectively. The new image output areas are specified in order to set the position corresponding to the convergent position before the change in the zoom magnification into the convergent position also after the change in the zoom magnification, that is, to cause the difference vector V12 to be zero between the reference point LP125 after the change in the zoom magnification corresponding to the reference point LP115 before the change in the zoom magnification illustrated in FIG. 12 and the corresponding point RP125 after the change in the zoom magnification corresponding to the corresponding point RP115 before the change in the zoom magnification illustrated in FIG. 12.

Herein, a magnitude ΔSa of the shifts of LS2 and RS2 can be derived from the following equation (5).

ΔSa=S2−S1 (5)

As described above, the parallax adjusting unit 122 gradually shifts the positions of the photographic image data for the left eye related to the image output area extracted from the photographic image data for the left eye and the photographic image data for the right eye related to the image output area extracted from the photographic image data for the right eye in accordance with the change in the magnifications of the zoom lenses L101 and R101.

As illustrated in FIG. 16, consequently, the parallax between the subject image data LP124 and RP124 is maintained to be zero and the imaging device 1 can output a 3D image maintaining a three-dimensionality intended before changing the optical zoom magnification by a user.

If the parallax adjusting unit 122 readjusts the parallax between the photographic image data for the left eye and the photographic image data for the right eye at the Step S108, the photographic information recording unit 123 records the magnifications of the zoom lenses L101 and R101 in the parallax adjustment and the size of the parallax adjusting image again (Step S109).

The processing for recording the photographic information is carried out in the same manner as in the Step S106. When the user drives the zoom actuators L110 and R110 to change the zoom magnification, the information about the zoom magnification thus changed is recorded in the photographic information recording unit 123 at each time so that the processing is executed. In the imaging device 1, accordingly, it is possible to adjust the parallax in accordance with the past change including the zoom magnification set finally by the user.

If the photographic information is completely recorded again at the Step S109 or the user does not change the zoom magnification (NO in the Step S107), the photographing operation is ended in accordance with the program through the integrated control of the CPU 120 in FIG. 1 when the user releases the picture recording button (not illustrated) of the operating unit 142 (YES in the Step S110).

Alternatively, the present processing for a through image which has been acquired may be ended when the user turns OFF the imaging device 1 to cancel the photographing mode by using a button (not illustrated) of the operating unit 142 or the like or when the user releases the picture recording button which is half-pushed. If the user does not end the photographing operation (NO in the Step S109), the same processing is repeated from the Step S101 again.

As described above, according to the imaging device 1 in accordance with the present invention, also in the case in which a slicing area from memory is regulated to adjust the parallax between the image data for the left eye and the image data for the right eye and the zoom magnification is then changed, the slicing areas of the image data for the left eye and the image data for the right eye are also changed in accordance with the change in the zoom magnification. Consequently, it is possible to generate a 3D image maintaining a three-dimensionality intended before the change in the zoom magnification after the change in the zoom magnification.

Although the description has been given by setting, as a premise, the processing for specifying the image output area in the photographic image data for the left eye and the photographic image data for the right eye which are temporarily stored in the SDRAM 133 and adjusting the parallax by setting the image area related to a shift as the parallax adjusting area, it is possible to obtain the same effects even if the same processing is executed over other memory or image sensors.

Although there has been omitted the description of an adjustment of a parallax in a vertical direction between photographic image data for the left eye and photographic image data for the right eye due to a shift in the vertical direction of the optical axis AL100 of the imaging unit L100 and the optical axis AR100 of the imaging unit R100 for simplicity of explanation, it is apparent that the same advantages can be obtained even if the processing according to the present invention is executed after the shift in the vertical direction is corrected by a well-known method.

According to the 3D imaging device in accordance with the present invention, the reading area in the horizontal direction of the image data transmitted from the memory is adjusted. Also in the case in which the parallax between the photographic images for left and right eyes is adjusted and the zoom magnification is then changed, consequently, the reading areas of the photographic images for left and right eyes are changed together with the change in the zoom magnification so that it is possible to generate a 3D image which maintains a three-dimensionality intended before the change in the zoom magnification also after the change in the zoom magnification.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A 3D imaging device comprising:
a first imaging unit having a first variable power lens and a first driving unit configured to drive the first variable power lens along an optical axis, and acquiring first photographic image data;
a second imaging unit haying a second variable power lens and a second driving unit configured to drive the second variable power lens along an optical axis, and acquiring second photographic image data;
a storage unit configured to temporarily store the first photographic image data and the second photographic image data;
a parallax determining unit configured to determine a parallax in a horizontal direction between the first photographic image data and the second photographic image data which are stored in the storage unit;
a parallax adjusting unit configured to generate a third photographic image data excluding a first parallax adjusting image data from the first photographic image data and a fourth photographic image data excluding a second parallax adjusting image data from the second photographic image data based on the parallax in the horizontal direction which is determined by the parallax determining unit; and
a photographic information recording unit configured to record a first photographic information and a second photographic information, the first photographic information being information about a magnification of the first variable power lens in an acquirement of the first photographic image data and a size of area of the first parallax adjusting image data, the second photographic information being information about a magnification of the second variable power lens in an acquirement of the second photographic image data and a size of area of the second parallax adjusting image data,
wherein when a fifth photographic image data with the magnification of the first variable power lens changed by the first driving unit is acquired from the third photographic image data and a sixth photographic image data with the magnification of the second variable power lens changed by the second driving unit is acquired from the fourth photographic image data the parallax adjusting unit determines sizes of areas of a third parallax adjusting image data and a fourth parallax adjusting image data based on the changed magnifications, the first photographic information, and the second photographic information recorded in the photographic information recording unit, generates a seventh photographic image data excluding the third parallax adjusting image data from the fifth photographic image data, and generates an eighth photographic image data excluding the fourth parallax adjusting image data from the sixth photographic image data.

2. The 3D imaging device according to claim 1, further comprising a face detecting unit configured to detect a face image of a person from the first photographic image data and the second photographic image data,
the parallax determining unit determining a parallax in a horizontal direction between the first photographic image data and the second photographic image data based on the face image detected by the face detecting unit.

3. The 3D imaging device according to claim 1, wherein the parallax determining unit calculates the greatest one of difference vectors of the first photographic image data and the second photographic image data, and an average of all of the difference vectors, and determines the parallax in the horizontal direction between the first photographic image data and the second photographic image data in such a manner that the greatest difference vector is the average of all of the difference vectors.

4. A 3D imaging method comprising:
a first imaging step causing a first imaging unit to acquire a first photographic image data by driving a first variable power lens;
a second imaging step causing a second imaging unit to acquire a second photographic image data by driving a second variable power lens;
a parallax determining step determining a parallax in a horizontal direction between the first photographic image data and the second photographic image data;
a parallax adjusting step generating a third photographic image data excluding a first parallax adjusting image data from the first photographic image data and a fourth photographic image data excluding a second parallax adjusting image data from the second photographic image data based on the parallax in the horizontal direction which is determined by the parallax determining step;
a photographic information recording step recording a first photographic information and a second photographic information, the first photographic information being information about a magnification of the first variable power lens in an acquirement of the first photographic image data and a size of area of the first parallax adjusting image data, the second photographic information being information about a magnification of the second variable power lens in an acquirement of the second photographic image data, a size of the first parallax adjusting image and a size of area of the second parallax adjusting image data; and
a generating step wherein when a fifth photographic image data with the magnification of the first variable power lens changed by the first driving unit is acquired from the third photographic image data and a sixth photographic image data with the magnification of the second variable power lens changed by the second driving unit is acquired from the fourth photographic image data, the parallax adjusting unit determines sizes of areas of a third parallax adjusting image data and a fourth parallax adjusting image data based on the changed magnifications and the photographic information recorded in the photographic information recording step, generates a seventh photographic image data excluding the third parallax adjusting image data from the fifth photographic image data, and generates an eighth photographic image data excluding the fourth parallax adjusting image data from the sixth photographic image data.
